(19) United States
(12) Patent Application Publication
(10) Pub. No.: US 2026/0081653 A1
(43) Pub. Date: Mar. 19, 2026

(54) CLOSED-LOOP ANTENNA SELECTION FOR A SINGLE TRANSMITTER WIRELESS DEVICE

(71) Applicant: Apple Inc., Cupertino, CA (US)

(72) Inventors: Lijie ZHANG, Beijing (CN); Lakshmi N. KAVURI, San Jose, CA (US); Lele CUI, Beijing (CN); Xiaolong TU, Shanghai (CN); Zhiwei WANG, Beijing City (CN)

(21) Appl. No.: 19/110,249

(22) PCT Filed: Sep. 23, 2022
(86) PCT No.: PCT/CN2022/120816

§ 371 Date: Mar. 10, 2025

(51) Int. Cl. H04B 7/06; H01Q 1/24; H04L 5/00; H04L 5/14

(52) U.S. Cl. CPC H04B 7/061; H01Q 1/246; H04L 5/0051; H04L 5/14

(57) ABSTRACT

This application describes mechanisms to manage closed-loop antenna selection for a wireless device. The wireless device transmits sounding reference signal (SRS) resources configured by a cellular wireless network in an SRS resource set and receive SRS indicator (SRI) values to indicate antennas for subsequent uplink transmission of one or more physical layer channels by the wireless device, including a physical uplink shared channel (PUSCH), a physical uplink control channel (PUCCH), and a physical random access channel (PRACH). The wireless device supplements the closed-loop antenna selection with an open-loop antenna selection and uses the open-loop antenna selection for non-PUSCH channels when a most recently SRI value can be considered stale. SRI-based closed-loop antenna selection is extended to frequency division duplexing (FDD) bands. Transmit precoding matrix indicator (TPMI) group values are also used to indicate differential transmit power capabilities of various antennas of the wireless device to the cellular wireless network.

### FIELD

The described embodiments relate to wireless communications, including methods and apparatus to manage closed-loop antenna selection for a single transmitter wireless device.

### BACKGROUND

Newer generation, e.g., fifth generation (5G) new radio (NR), cellular wireless networks that implement one or more 3^{rd} Generation Partnership Project (3GPP) 5G standards are rapidly being developed and deployed by network operators worldwide. The newer cellular wireless networks provide a range of packet-based services, with 5G technology providing increased data throughput and lower latency connections that promise enhanced mobile broadband services for wireless devices. The higher data throughput and lower latency of 5G is expected to usher in a range of new applications and services as well as improve existing ones. A wireless device sends in the uplink (UL) direction to a cellular wireless network one or more sounding reference signals (SRSs) configured by the cellular wireless network to measure UL channels for subsequent UL data and/or control signal transmissions. A single transmitter wireless device can include multiple receivers that can process signals received via multiple antennas (which in some cases can be mapped via a receiver transform filter matrix to one or more antenna ports that feed the receivers). With only one transmitter, the wireless device can transmit in the uplink direction using only one antenna port (which in the simplest case can be mapped to a single antenna) at any given time instant. Different antennas (or equivalently antenna ports) can provide different UL transmission characteristics based on how the wireless device is being used, e.g., device physical orientation, antenna blockage, etc. Performance of UL transmission can vary for the different antennas. The wireless device can select an antenna to use based on an open-loop antenna selection procedure, e.g., using measured downlink (DL) signal strength and/or signal quality metrics to infer UL channel characteristics or based on a closed-loop antenna selection procedure, e.g., using an antenna selection provided by feedback from the cellular wireless network in response to measurements taken by the cellular wireless network based on reception of the UL SRS transmissions sent by the wireless device. Present 5G wireless communication standards provide for closed-loop antenna selection based on UL SRS transmissions for time division duplexing (TDD) radio frequency (RF) band configurations and apply to the physical uplink shared channel (PUSCH) physical layer channel. There exists a need for mechanisms to extend closed-loop antenna selection for a single transmitter wireless device to additional RF band configurations, other physical layer channels, with enhanced performance when used therewith.

### SUMMARY

This application relates to wireless communications, including methods and apparatus to manage closed-loop antenna selection for a single transmitter wireless device. A cellular wireless network configures one or more sounding reference signal (SRS) resource sets to the wireless device, each SRS resource set including one or more SRS resources for uplink (UL) transmission. The wireless device transmits the SRS resources to the cellular wireless network via one or more antennas for uplink (UL) channel measurements to determine UL transmission parameters for the wireless device to use subsequently for certain UL transmissions. The cellular wireless network provides closed-loop feedback via SRS indicator (SRI) values to indicate antennas selected by the cellular wireless network for UL transmission by the wireless device. In some embodiments, when operating using a frequency division duplexing (FDD) radio frequency (RF) band with the wireless device, the cellular wireless network configures an SRS resource set with multiple, e.g., two or four, SRS resources with a codebook usage designation. Each SRS resource includes one SRS port corresponding to a single antenna (or antenna port). To allow for antenna switching by the wireless device when an SRS resource will be transmitted via a first antenna port in a first orthogonal frequency division multiplexing (OFDM) symbol near to a physical layer channel transmission via a second antenna port in a second OFDM symbol, the cellular wireless network does not schedule UL transmissions during at least one OFDM symbol interposed between the first OFDM symbol and the second OFDM symbol that are transmitted via different antenna ports. In some embodiments, the wireless device extends the use of SRI-based feedback from the PUSCH to additional physical layer channels, including the physical uplink control channel (PUCCH) and the physical random access channel (PRACH), using the same antenna selected for the PUSCH for UL transmission via the PUCCH and the PRACH that occur within a back-off time period of the SRI most recently received from the cellular wireless network. For PUCCH or PRACH transmissions that occur outside the back-off time period, the wireless device selects an antenna port for transmission of the PUCCH or the PRACH using an open-loop antenna selection procedure, e.g., based on measurements of downlink (DL) signals received by the wireless device from the cellular wireless network. The wireless device adaptively determines UL transmit power levels for each UL physical channel differently using either i) DL path loss measurements obtained via the closed-loop SRI-selected antenna or ii) DL path loss measurements obtained via the open-loop antenna selection. UL transmit power levels for the PUSCH are calculated to accommodate higher modulation and coding selection (MCS) values. UL transmit power levels for the PRACH are calculated to achieve higher UL performance. UL transmit power levels for the PUCCH are calculated to achieve stable performance with lower UL transmit power levels and less interference at the cellular wireless network receiver. In some embodiments, the cellular wireless network configures an SRS resource with four SRS resources, each SRS resource corresponding to a single antenna port, to the wireless device based on the wireless device reporting a full power mode 2 configuration with only one transmit layer supported (no support for UL multiple-input multiple-output transmission with multiple transmit layers). The wireless device transmits the four SRS resources and receives an antenna selection from the cellular wireless network via downlink control information (DCI). In some embodiments, the wireless device reports the full power mode 2 configuration with one transmit layer supported and additionally reports a transmit precoding matric indicator (TPMI) group of either two ports release 16 (r16) or four ports non-coherent r16 configuration. The two ports TPMI group designation is used when the wireless device supports closed-loop antenna selection using two SRS resources, while the four ports TPMI group designation is used when the wireless device supports closed-loop antenna selection using four SRS resources. Specific values for the TPMI group are provided to the cellular wireless network to indicate a relative transmit power capability, e.g., a maximum transmit power level (MTPL) value, of the various antennas (or antenna ports) of the wireless device. The cellular wireless network can use the reported TPMI group to compensate for MTPL differences between different antennas (or antenna ports) of the wireless device when performing UL channel estimation using SRS resources transmitted by the various antennas (or antenna ports) and thereby improve antenna (or antenna port) selection based on more accurate MTPL values available for transmissions via the antennas (or antenna ports).

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIGS. 1A, 1B, 1C, and 1D illustrate diagrams of examples of closed-loop antenna selection for a wireless device, according to some embodiments.

FIG. 1E illustrates an example of open-loop antenna selection by a wireless device, according to some embodiments.

FIG. 1F illustrates an example of closed-loop antenna selection by a wireless device, according to some embodiments.

FIG. 1G illustrates an exemplary uplink transmit chain for a wireless device, according to some embodiments.

FIG. 2A illustrates an exemplary 5G new radio (NR) physical layer frame structure, according to some embodiments.

FIG. 2B illustrates an example of SRS and PUSCH slot management for a wireless device operating in an FDD band, according to some embodiments.

FIG. 3A illustrates an example of antenna selection for non-PUSCH channels by a wireless device, according to some embodiments.

FIG. 3B illustrates an example of UL transmit power calculation using channel dependent path loss by a wireless device, according to some embodiments.

FIG. 4 illustrates a table of an example of reporting antenna maximum transmit power level (MTPL) values by a wireless device using transmit precoding matrix indicator (TPMI) values, according to some embodiments.

FIG. 5 illustrates an exemplary method for closed-loop uplink (UL) transmit antenna selection for a wireless device communicating with a base station of a cellular wireless network, according to some embodiments.

FIG. 6 illustrates an exemplary method for uplink (UL) transmit antenna selection for a wireless device communicating with a base station of a cellular wireless network, according to some embodiments.

FIG. 7 illustrates another exemplary method for uplink (UL) transmit antenna selection for a wireless device communicating with a base station of a cellular wireless network, according to some embodiments.

FIG. 8 illustrates an exemplary method for communicating maximum transmit power level (MTPL) information for multiple antenna ports of a wireless device to a base station of a cellular wireless network, according to some embodiments.

FIG. 9 illustrates a block diagram of exemplary elements of a mobile wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

This application relates to wireless communications, including methods and apparatus to manage closed-loop antenna selection for a single transmitter wireless device. A cellular wireless network configures one or more sounding reference signal (SRS) resource sets to the wireless device, each SRS resource set including one or more SRS resources for uplink (UL) transmission. The wireless device can be configured with multiple SRS resources sets used for different purposes and with different properties, such as periodic or aperiodic transmission. The wireless device transmits the SRS resources periodically, when designated periodic, or triggered by a downlink control information (DCI), when designated aperiodic, to the cellular wireless network via one or more antennas. The SRS resources can be used by for uplink (UL) channel measurements to determine UL transmission parameters for the wireless device to use subsequently for certain UL transmissions, such as for selecting one or more antennas or a precoding matrix to use. SRS ports can be mapped via a spatial filter to physical antennas; however, to simplify description here, it is assumed that individual SRS resources map to antennas directly. The ideas described here can also apply to mapping of SRS resources (or SRS ports) to antenna ports that map to combinations of physical antennas (e.g., UL beam-forming) as well. Each SRS resource set is designated with a usage configuration parameter indicating how the SRS resource set is to be used. The SRS resource sets described herein are designated with a codebook usage to be used for UL channel measurements and estimation with subsequent use for transmission of physical layer channels, specifically a physical uplink shared channel (PUSCH) with extensions for use on a physical uplink control channel (PUCCH) and a physical random access channel (PRACH). In the 5G cellular wireless communication standard, the SRS resource can be transmitted within the last six orthogonal frequency division multiplexing (OFDM) symbols of a slot or for later revisions more flexibly assigned to various OFDM symbols within a slot.

The wireless device signals its transmission capability regarding antenna switching to the cellular wireless network. A wireless device with only one transmit chain and four receive chains, denoted as a 1T4R capability, can only provide partial sounding (i.e., full sounding sending different SRS resources via all four antennas at once is not supported) and therefore antenna switching is required to sound all of the different possible uplink channels via the four different antennas (or more generally via four antenna ports that correspond to combinations of antennas of the wireless device). The cellular wireless network can configure a 1T4R wireless device with i) one SRS resource set having two SRS resources, ii) two SRS resource sets have two SRS resources each, or iii) one SRS resource set having four SRS resources. Each SRS resource includes one SRS port. The wireless device selects antennas through which to transmit the different SRS resources (at times designated by the cellular wireless network), and the cellular wireless network provides closed-loop feedback via SRS indicator (SRI) values to indicate antennas selected by the cellular wireless network for UL transmission by the wireless device. Presently, wireless devices with closed-loop SRI-based antenna switching for time-division duplexing (TDD) configurations are being designed and adopted; however, closed-loop SRI-based antenna switching for frequency-division duplexing (FDD) configurations has not yet been supported. Wireless devices communicate in a single, common frequency band when operating in a TDD configuration, where downlink-uplink reciprocity can apply, while wireless devices operating in an FDD configuration use separate frequency bands that will have different path loss characteristics. Present solutions allocate only one SRS resource for FDD bands (and therefore no selection of an SRS resource is available). New solutions described herein configure multiple SRS resources to a wireless device operating in an FDD configuration and use SRI values to enable closed-loop antenna selection for FDD bands.

To extend the use of closed-loop SRI-based antenna switching to FDD bands, in some embodiments, a wireless device that is configured to operate using an FDD band can receive from a cellular wireless network an SRS resource set configuration that includes multiple, e.g., two or four, SRS resources (instead of only a single SRS resource) with a codebook usage designation. Each SRS resource in the SRS resource set includes one SRS port and can correspond to a single antenna (or antenna port). The wireless device can transmit an SRS resource corresponding to a different antenna (or antenna port) that currently used for a physical uplink channel (e.g. for the PUSCH) and need to switch antennas before transmitting the SRS resource. To allow for antenna switching by the wireless device when the SRS resource will be transmitted via a first antenna port in a first OFDM symbol near to a physical layer channel transmission, such as a PUSCH transmission, via a second antenna port in a second OFDM symbol, the cellular wireless network refrains from scheduling UL transmissions during at least one OFDM symbol interposed between the first OFDM symbol (used for the SRS resource transmission) and the second OFDM symbol (used for the physical layer channel) that are transmitted via different antenna ports. Note that the first and second OFDM symbols can occur in either order and in the same time slot or in different time slots. For the case of the same time slot, with a PUSCH transmission (or other physical layer channel transmission that uses the same antenna selection as the PUSCH as described further herein) using antenna port A in time slot N and an SRS resource scheduled (or triggered) for transmission using antenna port B in the same time slot N, the cellular wireless network ensures at least one OFDM symbol separates the PUSCH OFDM symbol using antenna port A from the OFDM symbol with the SRS resource using antenna port B. For the case of sequential time slots, with an SRS resource scheduled (or triggered) for transmission using antenna port B in time slot N and a PUSCH (or other physical layer channel transmission that uses the same antenna selection as the PUSCH) using antenna port A in subsequent time slot N+1, the cellular wireless network again ensures at least one OFDM symbol separates the SRS resource OFDM symbol from the PUSCH OFDM symbol. The at least one intervening OFDM symbol interposed between the SRS resource OFDM symbol and the PUSCH OFDM symbol allows for antenna switching to occur. In some embodiments, the cellular wireless network schedules multiple SRS resources to be transmitted by the wireless device during one or more OFDM symbols of the same time slot, which allows for efficient UL channel sounding by the wireless device through different antennas using the multiple SRS resources and reduces the overhead incurred by the interposed OFDM symbol.

In some embodiments, the wireless device extends the use of SRI-based feedback for closed-loop antenna selection by the wireless device from the PUSCH to additional physical layer channels, including the physical uplink control channel (PUCCH) and the physical random access channel (PRACH). The wireless device can use the same antenna selected for the PUSCH for UL transmissions via the PUCCH and the PRACH that occur within a back-off time period of the SRI most recently received from the cellular wireless network. The wireless device can start (or reset) a back-off timer each time a valid SRI is received from the cellular wireless network, where a duration of the back-off timer is configurable. When the back-off timer has not expired, the wireless device can use the same antenna for the PUCCH and PRACH as selected for the PUSCH. For PUCCH or PRACH transmissions that occur outside the back-off time period, e.g., after the back-off timer has expired, the wireless device selects an antenna port for transmission of the PUCCH or the PRACH using an open-loop antenna selection procedure, e.g., based on measurements of downlink (DL) signals received by the wireless device from the cellular wireless network. In some cases, the open-loop selected antenna used for the PUCCH and the PRACH can be the same as the closed-loop selected antenna used for the PUSCH. In some cases, the open-loop selected antenna used for the PUCCH and the PRACH can differ from the closed-loop selected antenna used for the PUSCH.

In some embodiments, the wireless device adaptively determines UL transmit power levels based on both a closed-loop power control mechanism, signaling by a transmit power control (TPC) command from the cellular wireless network, and based on an open-loop power control mechanism implemented at the wireless device using DL measurements. Power for UL transmissions are controlled to ensure comparable receive levels for UL transmissions from different wireless devices at the cellular wireless network. Transmit power levels much higher for one wireless device than another wireless device can cause unwanted interference. The wireless device uses DL path loss measurements of wireless signals received from the cellular wireless network to estimate the amount of attenuation UL wireless signals will incur when transmitted to the cellular wireless network based on a reciprocity principle. The actual amount of path loss incurred will depend on the antenna (or antenna port) selected for the UL transmission. The wireless device can calculate UL transmission power differently for each UL physical channel using either i) DL path loss measurements obtained via the closed-loop SRI selected antenna or ii) DL path loss measurements obtained via the open-loop antenna selection. UL transmit power levels for the PUSCH can be calculated using the DL path loss measurements obtained via the open-loop antenna selection. This provides a constant (over a time-frame during which a most recent DL path loss measurement via the open-loop antenna selection procedure is valid) DL path loss value aligned between the wireless device and the cellular wireless network. UL performance for the PUSCH can accommodate higher modulation and coding selection (MCS) values in some situations, such as when the actual UL path loss is less than the measured DL path loss used for the UL transmit power level calculation, as the resulting UL received power level at the cellular wireless network for the PUSCH can be higher. UL transmit power levels for the PRACH can also be calculated using the DL path loss measurements obtained via the open-loop antenna selection and can thereby achieve higher performance for the PRACH based on higher UL transmit power levels. UL transmit power levels for the PUCCH can be calculated using the corresponding antenna used for the PUCCH transmission, i.e., the DL path loss measurement obtained via the closed-loop SRI-selected antenna, when using the SRI-selected antenna for the PUCCH, and the DL path loss measurement obtained via the open-loop antenna, when using the open-loop antenna for the PUCCH. The DL path loss measurements are selected according to the corresponding antenna used for the PUCCH to achieve stable performance with lower UL transmit power levels resulting in less interference when received at the cellular wireless network, as the PUCCH is a shared channel used by other wireless devices as well as the wireless device.

In some embodiments, the cellular wireless network configures an SRS resource with four SRS resources, each SRS resource corresponding to a single antenna (or antenna port), to the wireless device based on the wireless device reporting a full power mode 2 configuration with only one transmit layer supported (where the single-transmitter wireless device does not support UL multiple-input multiple-output transmission with multiple transmit layers). By using the full power mode 2 configuration, the wireless device can be configured with an SRS resource set that includes four SRS resources (rather than be limited to only two SRS resources as in presently available configurations). The wireless device transmits the four SRS resources via four different antennas (or antenna ports) and receives an antenna selection from the cellular wireless network via SRI values in downlink control information (DCI).

In some embodiments, the wireless device reports the full power mode 2 configuration with one transmit layer supported and additionally reports a transmit precoding matrix indicator (TPMI) group value to communicate to the cellular wireless network maximum transmit power level (MTPL) capability of antennas (or antenna ports) of the wireless device. The wireless device can report a two-port release 16 (r16) configuration or a four port non-coherent r16 configuration for the TPMI Group r16 value. The two port TPMI group designation is used when the wireless device supports closed-loop antenna selection using two SRS resources, while the four port TPMI group designation is used when the wireless device supports closed-loop antenna selection using four SRS resources. The wireless device maps physical antennas (or antenna ports) of the wireless device to codebook-usage SRS resources based on values of the TPMI group. Specific values for the TPMI group are provided to the cellular wireless network to indicate a relative transmit power capability, e.g., a maximum transmit power level (MTPL) value, of the various antennas (or antenna ports) of the wireless device. When the two port r16 configuration is used, the wireless device maps antennas (or antenna ports) with higher MTPL values to the reported port index. When the four port non-coherent r16 configured is used, the wireless device maps antennas (or antenna ports) to G0, G1, G2 and G3 values to correspond to certain antennas (or antenna ports) that have higher MTPL values. The cellular wireless network can read the reported TPMI group value and use a transmit power adjustment (e.g., 3 dB) for antennas (or antenna ports) that have different MTPL values, e.g., some antennas (or antenna ports) support higher maximum transmit power levels and other antennas support lower maximum transmit power levels. In some cases, the SRS resource is transmitted as a wideband signal near (or at) an MTPL level for the corresponding antenna, while subsequent UL signals, e.g., the PUSCH, PUCCH, or PRACH, can be narrowband signals that are transmitted at lower power levels. The cellular wireless network can account of transmit power level differences when estimated signal metrics based on received SRS resources and when selecting antennas (or antenna ports) for the wireless device to subsequently use based on the estimated performed using the received SRS resources.

In some embodiments, the cellular wireless network uses a power headroom report (PHR) provided by the wireless device to determine an MTPL value for an antenna (or antenna port). The cellular wireless network can transmit to the wireless device an SRI, which designates an antenna (or antenna port) for the wireless device to use, near expiration of a PHR periodic timer. Upon expiration of the PHR periodic timer, the wireless device determines and provides a PHR value to the cellular wireless network. The PHR received by the cellular wireless network can correspond to the antenna (or antenna port) selected by the SRI. The cellular wireless network can accumulate PHR values for each of the antennas (or antenna ports) by cycling through different SRI values and use the PHR values to determine MTPL values for the corresponding antennas (or antenna ports). With the MTPL values for the various antennas (or antenna ports), the cellular wireless network can apply MTPL differences to estimated SRS signal metrics when selecting an antenna (or antenna port) for the wireless device to use (subsequently designated in an SRI sent to the wireless device).

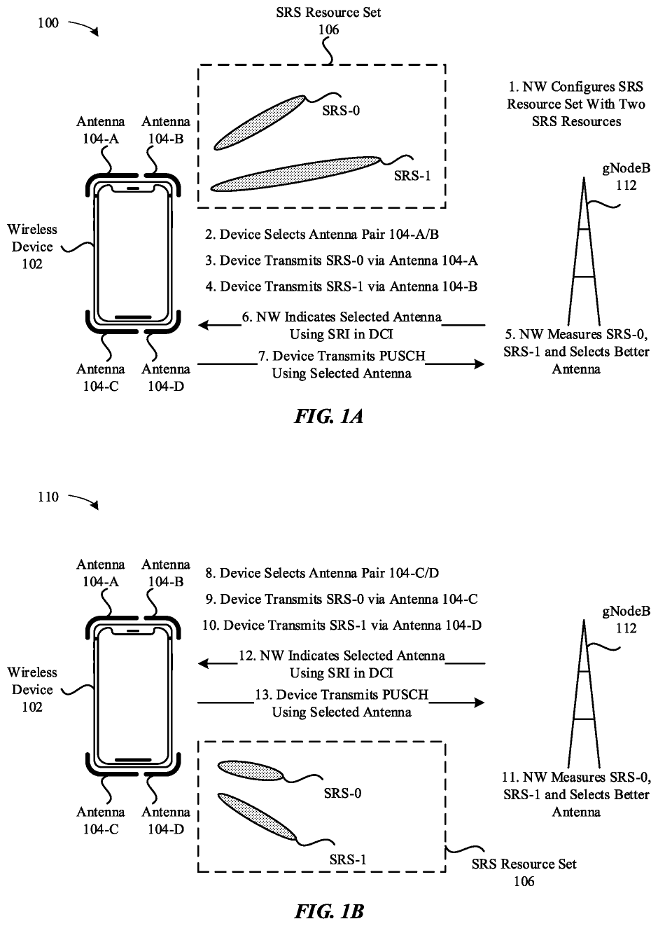

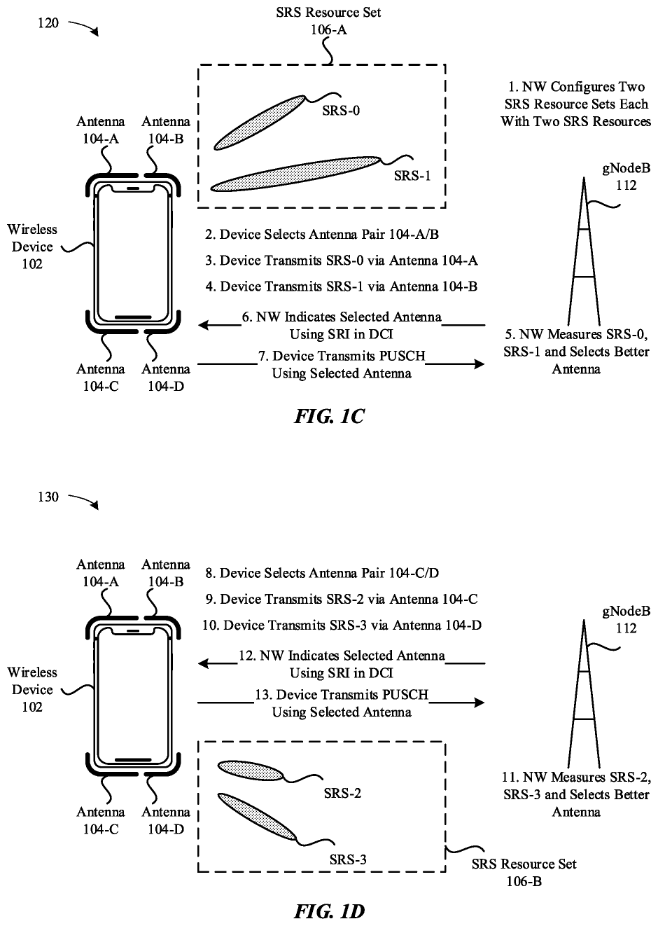

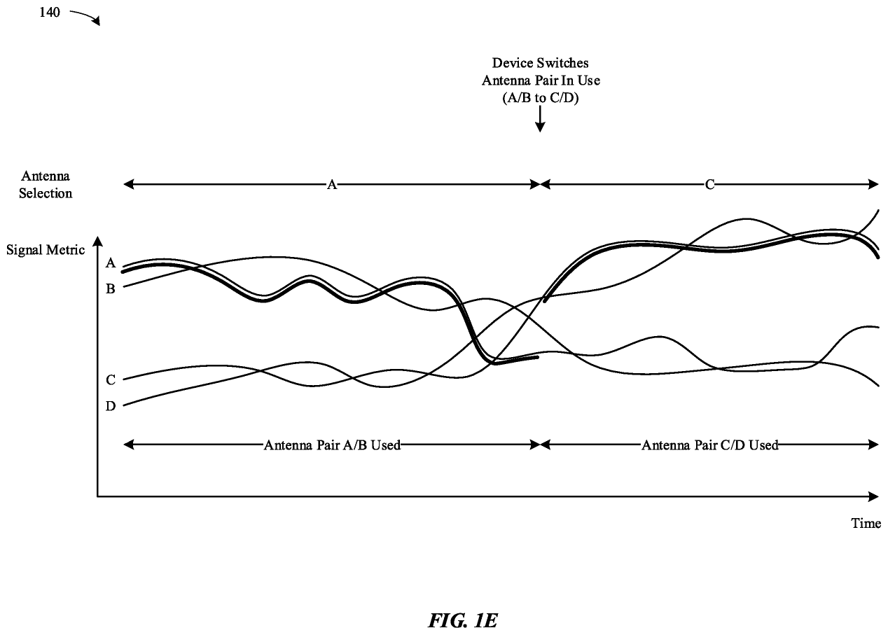

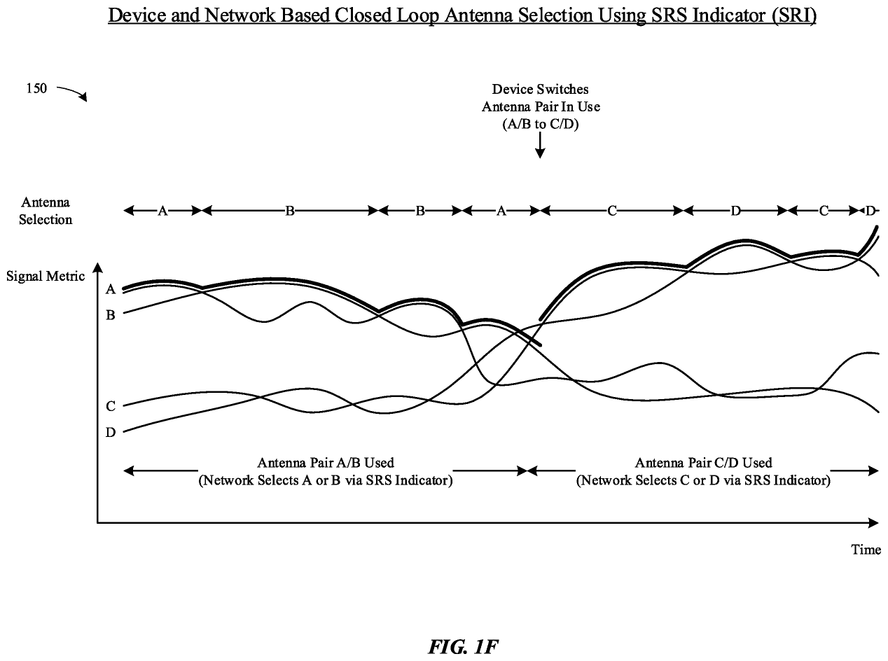

These and other embodiments are discussed below with reference to FIGS. 1 through 9; however, those skilled in the art will readily appreciate that the detailed description given herein with respect to these figures is for explanatory purposes only and should not be construed as limiting.

FIGS. 1A and 1B illustrate block diagrams 100, 110 of an exemplary system configured to implement closed-loop antenna selection for a wireless device 102. The wireless device 102 includes a single transmitter (transmit chain) and multiple receivers (receive chains) communicatively coupled to multiple antennas 104-A, 104-B, 104-C, and 104-D. The single transmitter of the wireless device 102 can send uplink (UL) signals via an individual antenna 104-A/B/C/D to a gNodeB 112 (base station) of a cellular wireless network and receive one or more downlink (DL) signals from the gNodeB 112 via one or more of the multiple antennas 104-A/B/C/D. In some embodiments, the wireless device 102 can transmit via multiple antennas 104-A/B/C/D simultaneously (beam-forming) to the gNodeB 112 of the cellular wireless network. The wireless device 102 can indicate to the gNodeB 112 of the cellular wireless network the transmit and receive capability of the wireless device 102, e.g., a one-transmit, four-receiver configuration, designated as 1T4R, for the wireless device 102. Based on how the wireless device 102 is being used, transmissions via different antennas 104-A/B/C/D can experience different uplink channel conditions to the gNodeB 112, based on orientation of the wireless device 102 and/or based on adjacent (or nearby) objects that block or interfere with radio frequency (RF) signals between the wireless device 102 and the gNodeB 112. Using an open-loop antenna selection procedure, the wireless device 102 can measured downlink (DL) signals received from the gNodeB 112, estimate a DL path loss for signals transmitted from the gNodeB 112 to the wireless device 102, and select an antenna 104-A/B/C/D for UL transmission based on the DL path loss, assuming reciprocity so that UL signals transmitted by the wireless device 102 to the gNodeB 112 experience UL path loss comparable to the DL path loss. Open-loop antenna selection, however, infers UL signal performance without feedback regarding UL performance from the gNodeB 112. Alternatively, using a closed-loop antenna selection procedure, the wireless device 102 can use an antenna 104-A/B/C/D for UL transmission based on an antenna selection obtained from the gNodeB 112, where the gNodeB 112 measures channel sounding reference signals transmitted by the wireless device 102 through the various antennas 104-A/B/C/D.

The gNodeB 112 can configure the wireless device 102 with a sounding reference signal (SRS) resource set 106 that includes two SRS resources, SRS-0 and SRS-1. In some embodiments, the gNodeB 112 configures the wireless device 102 with multiple SRS resource sets 106, where each SRS resource set 106 can be used for different purposes. The SRS resource set 106 can be designated for use with a specific UL physical layer channel, e.g., the physical uplink shared channel (PUSCH). Each SRS resource set 106 can also be designated for periodic, sim-persistent, or aperiodic transmission. In some embodiments, the SRS resource set 106 configured to the wireless device 102 is designated as periodic, and the gNodeB 112 expects the wireless device 102 to periodically transmit the SRS resources of the SRS resource set 106 to measure UL channels. In some embodiments, the SRS resource set 106 configured to the wireless device 102 is designated as aperiodic, and the gNodeB 112 sends a downlink control information (DCI) message to the wireless device 102 to trigger transmission of the SRS resources of the SRS resource set 106 at specified times for UL channel measurement. The wireless device 102 selects an antenna pair, e.g., 104-A/B, and transmits the two SRS resources, SRS-0 and SRS-1, via the individual antennas (or antenna ports) 104-A and 104-B respectively during one or more orthogonal frequency division modulation (OFDM) symbols of a slot of an UL OFDM frame sent to the gNodeB 112. The gNodeB 112 of the cellular wireless network measures the received SRS resource signals SRS-0 and SRS-1 and selects an antenna for the wireless device 102 to subsequently use for PUSCH transmission based on the measurements of the received SRS resource signals SRS-0 and SRS-1. The gNodeB 112 provides an indication of the antenna selected by sending an SRS indicator (SRI) value to the wireless device 102 designating the SRS resource signal that corresponds to the selected antenna. For example, with a one-bit valued SRI, an SRI value of ‘0’ can correspond to SRS-0, while an SRI value of ‘1’ can correspond to SRS-0. The wireless device 102 knows through which antenna (or antenna port) 104-A or 104-B the different SRS resource signals SRS-0 and SRS-1 were transmitted and can infer an antenna selection from the SRI value. The wireless device 102 subsequently transmits the PUSCH using the selected antenna 104-A or 104-B to the gNodeB 112.

The wireless device 102 can later use an open-loop antenna selection procedure to switch to using a different antenna pair, e.g., antennas 104-C/D. The wireless device 102 can transmit the SRS resources, SRS-0 and SRS-1, via the individual antennas (or antenna ports) 104-C and 104-D respectively during one or more OFDM symbols of a slot of an UL OFDM frame sent to the gNodeB 112. The gNodeB 112 of the cellular wireless network measures the received SRS resource signals SRS-0 and SRS-1 and selects an antenna for the wireless device 102 to subsequently use for PUSCH transmission based on the measurements of the received SRS resource signals SRS-0 and SRS-1. The gNodeB 112 provides an indication of the antenna selected by sending another SRI value to the wireless device 102 designating the SRS resource signal that corresponds to the selected antenna. The wireless device 102 again knows through which antenna (or antenna port) 104-C or 104-D the different SRS resource signals SRS-0 and SRS-1 were transmitted and can infer an antenna selection from the SRI value. The wireless device 102 subsequently transmits the PUSCH using the selected antenna 104-C or 104-D to the gNodeB 112.

FIGS. 1C and 1D illustrate block diagrams 120, 130 of another example of closed-loop antenna selection for a wireless device 102. The gNodeB 112 can configure the wireless device 102 with two sounding reference signal (SRS) resource sets 106-A/B that each include two SRS resources, a first SRS resource set 106-A with SRS-0 and SRS-1 and second SRS resource set 106-B with SRS-2 and SRS-3. The SRS resource set 106-A/B can be designated for channel estimation by the gNodeB 112 and subsequent transmission of the PUSCH by the wireless device 102 based on an antenna selection provided to the wireless device 102 by the gNodeB 112. The wireless device 102 can associate the first resource set 106-A with two antennas (or antenna ports), e.g., 104-A/B, and the second resource set 106-B with two other antennas (or antenna ports), e.g., 104-C/D. The wireless device 102 can select one of the antenna pairs, e.g., 104-A/B, and transmit the SRS resources of the SRS resource set 106-A via the selected antenna pair, e.g., SRS-0 via antenna (or antenna port) 104-A and SRS-1 via antenna (or antenna port) 104-B. The gNodeB 112 measures the received SRS resources SRS-0 and SRS-1, determines channel properties for UL transmission via antenna (or antenna port) 104-A/B and selects an antenna (or antenna port) based on the measured channel properties. The gNodeB 112 sends to the wireless device 102 a DCI message include an SRI value that indicates the SRS resource corresponding to the selected antenna (or antenna port). The wireless device 102 subsequently transmits the PUSCH using the selected antenna.

The wireless device 102 can later use an open-loop antenna selection procedure to switch to using a different antenna pair, e.g., antennas 104-C/D. The wireless device 102 can transmit the SRS resources, SRS-2 and SRS-3, of the second SRS resource set 106-B via the individual antennas (or antenna ports) 104-C and 104-D respectively. The gNodeB 112 measures the received SRS resource signals SRS-2 and SRS-3 and selects an antenna for the wireless device 102 to subsequently use for PUSCH transmission based on the measurements of the received SRS resource signals SRS-2 and SRS-3. The gNodeB 112 provides an indication of the antenna selected by sending another DCI message including an SRI value to the wireless device 102 designating the SRS resource signal that corresponds to the selected antenna. For example, with a one-bit valued SRI, an SRI value of ‘0’ can correspond to SRS-2, while an SRI value of ‘1’ can correspond to SRS-3. The wireless device 102 again knows through which antenna (or antenna port) 104-C or 104-D the different SRS resource signals SRS-2 and SRS-3 were transmitted and can infer an antenna selection from the SRI value. The wireless device 102 subsequently transmits the PUSCH using the selected antenna 104-C or 104-D to the gNodeB 112.

FIG. 1E illustrates a diagram 140 of an example of open-loop antenna selection by a wireless device 102 without feedback from the cellular wireless network. The wireless device 102 can select an antenna (or antenna port) based on signals received via each of multiple antennas (or antenna ports) in the downlink direction from the cellular wireless network, e.g., based on signal strength metrics that can be used to measure a downlink path loss from the cellular wireless network to the wireless device 102 for different downlink channels via each of the antennas and infer an uplink path loss to the cellular wireless network for transmissions via the same antennas. The wireless device 102 can select an antenna pair, e.g., A/B or C/D, and an antenna from the antenna pair, e.g., A or B, when using antenna pair A/B, or C or D, when using antenna pair C/D based on the measurements. In some embodiments, the open-loop antenna selection procedure changes between antenna pairs (if measurements indicate switching would be beneficial) on the order of multiple seconds. With open-loop antenna selection only, the wireless device 102 does not select the individual antenna used from the selected antenna pair based on feedback from the cellular wireless network and instead relies on its own determination. The example shown in FIG. 1E illustrates the wireless device 102 selecting antenna pair A/B for a first time period, with antenna A being selected over antenna B throughout the first time period. Subsequently, the wireless device selects antenna pair C/D for a second time period, with antenna C being selected over antenna D throughout the second time period. The signal metrics for the selected antennas are indicated as the bold lines. As illustrated, the wireless device 102 would benefit from switching between antenna A and antenna B during the first time period and switching between antenna C and antenna D during the second time period; however, the open-loop antenna selection procedure used may not provide opportunities for re-measurement and switching of antennas within a time period. As shown next, closed-loop antenna selection of individual antennas to supplement open-loop antenna selection of antenna pairs can improve performance for the wireless device 102.

FIG. 1F illustrates a diagram 150 of an example of closed-loop antenna selection by a wireless device 102 with feedback from the cellular wireless network. The wireless device 102 selects an antenna pair based on measurements of signals received via each of multiple antennas in the downlink direction from the cellular wireless network, e.g., DL path loss measurements. The wireless device 102 selects an antenna pair, e.g., A/B or C/D, based on the measurements. The wireless device 102 can also send UL signals, e.g., SRS resources of an SRS resource set 106 (or from multiple SRS resource sets 106) to the cellular wireless network via each of the multiple antennas and receive in response a DCI message include an SRI that designates one of the multiple antennas to use for subsequent UL transmission, e.g., for PUSCH transmissions. As with the example of FIG. 1E, the open-loop antenna selection procedure changes between antenna pairs (if measurements indicate switching would be beneficial) on the order of multiple seconds. The example of FIG. 1F illustrates the wireless device 102 selecting antenna pair A/B for a first time period and antenna pair C/D for a second time period. During each time period, the wireless device 102 transmits SRS resources (either periodically based on a periodic configuration of the SRS resource set 106 or on demand in response to a DCI message from the cellular wireless network requesting an SRS measurement based on an aperiodic configuration of the SRS resource set 106). The cellular wireless network sends DCI messages with SRI values to the wireless device 102 to indicate selection of an antenna of an antenna pair in use, e.g., antenna A or B during the first time period and antenna C or D during the second time period. The combination of open-loop antenna pair selection based on DL measurements by the wireless device 102 (or more generally selection of a group of antennas or antenna ports) and closed-loop antenna (or antenna port) selection from the antenna pair (or group of antennas or antenna ports) based on UL measurements with feedback to the wireless device 102 provides superior performance as illustrated by the bolded signal metric for the selected antennas.

FIG. 1G illustrates a diagram 160 of an exemplary uplink transmit chain for the wireless device 102. A transmitter 180 can receive a digital data stream 162 for uplink data to be communicated wirelessly to a cellular wireless network through one or more antenna ports 174. A digital-to-analog converter (DAC) 164 of the transmitter 180 converts the digital data stream 162 into an analog signal which is modulated onto an uplink radio frequency (RF) carrier by a modulator 166 of the transmitter 180. The modulated analog signal is amplified by a power amplifier 168 and filtered through a suitable transmit (TX) filter 170 resulting in an amplified analog transmit data signal 172 that is transmitted wirelessly a radio link to a cellular wireless network via one or more antenna ports 174. When multiple antenna ports 174 (or antennas) are used, an UL transmission can be referred to as a multiple input multiple output (MIMO) transmission, and can be used to improve data throughput and/or transmission reliability. The UL transmission output from the antenna ports 174 of the wireless device 102 are transmitted at a power level to allow for proper reception by cells of the cellular wireless network. The UL transmissions are limited by the wireless circuitry of the transmitter 180 and the transmission properties of the antenna ports 174. The UL transmissions from all antenna ports 174 of the wireless device 102 are required to meet regulatory requirements, such as a specific absorption rate (SAR) limit for human exposure to radio frequency (RF) energy. A maximum transmit power limit (MTPL) can be determined by the wireless device 102 for transmission via radio links used for UL transmission.

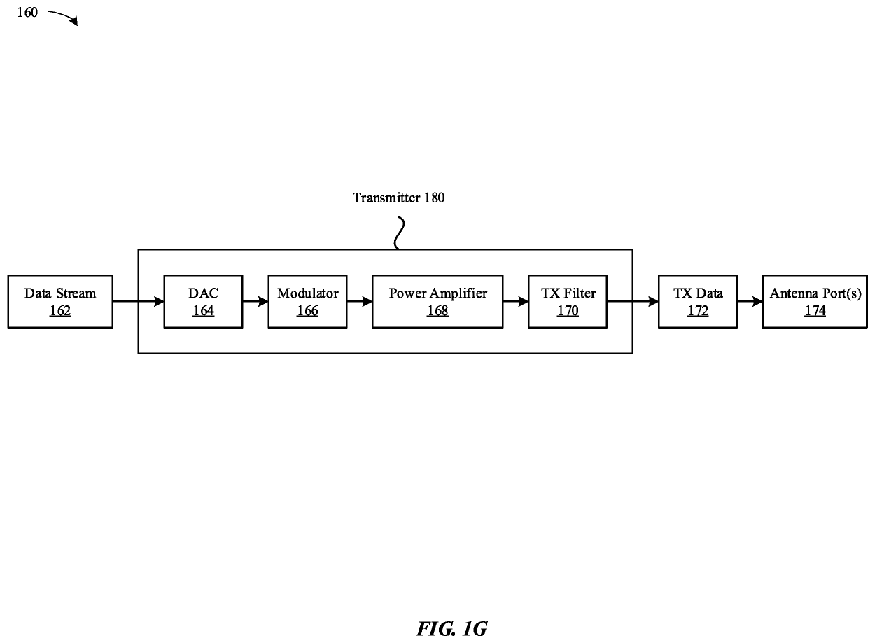

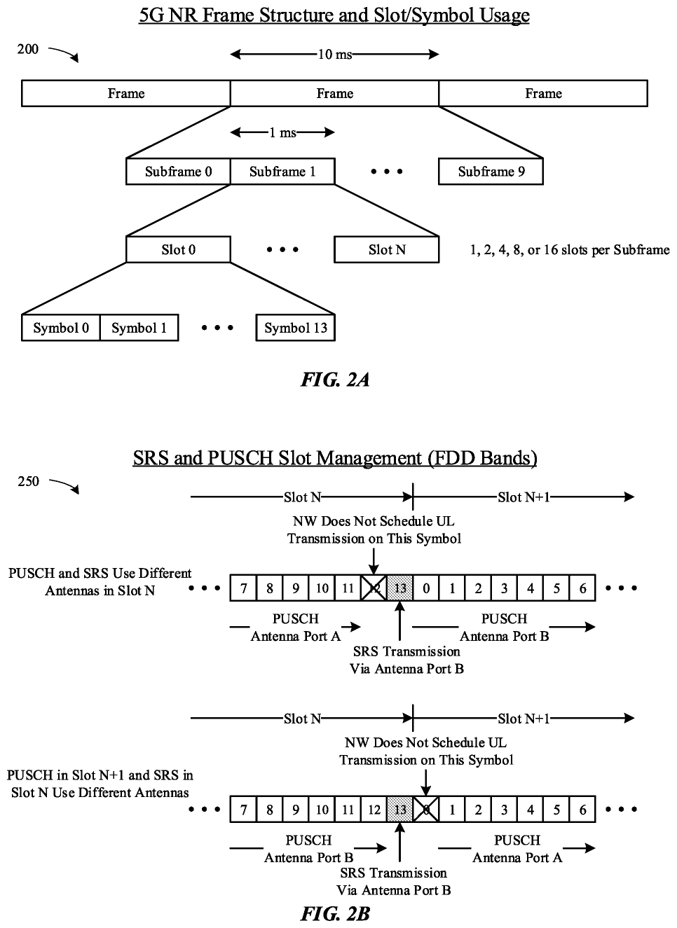

FIG. 2A illustrates a diagram 200 of an exemplary 5G NR physical layer time-domain frame structure with slot and symbol usage. NR transmissions are grouped into frames that each span 10 ms and are divided into equal sized subframes of 1 ms each. Subframes are divided into one, two, four, eight, or sixteen slots each depending on the length of OFDM symbols within the slots, where the length of an OFDM symbol depends on subcarrier spacing used for the OFDM transmission. Each slot includes 14 symbols. SRS resources are transmitted in the uplink direction in one, two or four adjacent OFDM symbols within the last six OFDM symbols of a single slot. In some extensions to the 5G NR wireless communication standard, the SRS resources can be transmitted in any of the OFDM symbols of a single slot. In the frequency domain (not shown), the SRS resources are transmitted on every second or every fourth subcarrier of the OFDM symbols used to allow for frequency multiplexing SRS from different wireless devices 102.

A wireless device 102 signals its transmission capability regarding antenna switching to a cellular wireless network. A wireless device with only one transmit chain and four receive chains, denoted as a 1T4R capability, can only provide partial sounding (i.e., full sounding sending different SRS resources via all four antennas at once is not supported) and therefore antenna switching is required to sound all of the different possible uplink channels via the four different antennas (or more generally via four antenna ports that correspond to combinations of antennas of the wireless device). The cellular wireless network can configure a 1T4R wireless device 102 with i) one SRS resource set 106 having two SRS resources (as shown in FIG. 1A/B), ii) two SRS resource sets 106 have two SRS resources each (as shown in FIG. 1B/C), or iii) one SRS resource set having four SRS resources (not shown). Each SRS resource includes one SRS port. The wireless device 102 selects antennas through which to transmit the different SRS resources (at times designated by the cellular wireless network), and the cellular wireless network provides closed-loop feedback via SRS indicator (SRI) values to indicate antennas selected by the cellular wireless network for UL transmission by the wireless device 102. Presently, cellular wireless communication standards allow closed-loop SRI-based antenna switching for time-division duplexing (TDD) configurations but do not allow closed-loop SRI-based antenna switching for frequency-division duplexing (FDD) configurations, as the cellular wireless network only allocates one SRS resource for FDD bands.

FIG. 2B illustrates a diagram 250 of an example of SRS and PUSCH slot management for a wireless device 102 operating in an FDD band. To extend the use of closed-loop SRI-based antenna switching to FDD bands, in some embodiments, a wireless device 102 that is configured to operate using an FDD band can receive from a cellular wireless network an SRS resource set 106 configuration that includes multiple, e.g., two or four, SRS resources (instead of only a single SRS resource) with a codebook usage designation. Each SRS resource in the SRS resource set 106 includes one SRS port and can correspond to a single antenna (or antenna port). The wireless device 102 can transmit an SRS resource via an antenna (or antenna port) than differs from the antenna (or antenna port) currently being used for a physical uplink channel (e.g., PUSCH) transmission. The wireless device 102 can switch antennas before transmitting the SRS resource via the different antenna (or antenna port). To allow for antenna switching by the wireless device 102, when the SRS resource will be transmitted via a first antenna port in a first OFDM symbol near to a physical layer channel transmission, such as a PUSCH transmission, via a second antenna port in a second OFDM symbol, the cellular wireless network refrains from scheduling UL transmissions during at least one OFDM symbol interposed between the first OFDM symbol (used for the SRS resource transmission) and the second OFDM symbol (used for the physical layer channel) that are transmitted via different antenna ports.

The first and second OFDM symbols used for SRS resource transmission and for PUSCH transmission respectively can occur in either order and in the same time slot or in different time slots. For the case where different antennas are used in the same time slot (upper diagram in FIG. 2B), a PUSCH transmission (or other physical layer channel transmission that uses the same antenna selection as the PUSCH as described further herein) uses antenna port A during OFDM symbol 11 in time slot N and an SRS resource is periodically scheduled (or triggered based on a DCI message) for transmission in OFDM symbol 13 using antenna port B in the same time slot N. The cellular wireless network ensures at least one OFDM symbol (e.g., OFDM symbol 12) separates the PUSCH OFDM symbol using antenna port A (OFDM symbol 11) from the OFDM symbol with the SRS resource using antenna port B (OFDM symbol 13). For the case of sequential time slots, with an SRS resource scheduled (or triggered) for transmission using antenna port B (e.g., in OFDM symbol 13) in time slot N and a PUSCH (or other physical layer channel transmission that uses the same antenna selection as the PUSCH) using antenna port A in subsequent time slot N+1, (e.g., in OFDM symbol 1), the cellular wireless network again ensures at least one OFDM symbol (in this example OFDM symbol 0 of slot N+1) separates the SRS resource OFDM symbol (OFDM symbol 13) from the PUSCH OFDM symbol (OFDM symbol 1). Interposing at least one intervening OFDM symbol between the SRS resource OFDM symbol and the PUSCH OFDM symbol allows for antenna switching to occur during the blocked out (no scheduled transmission) OFDM symbol. In some embodiments, the cellular wireless network schedules multiple SRS resources to be transmitted by the wireless device during one or more OFDM symbols of the same time slot, which allows for efficient UL channel sounding by the wireless device through different antennas using multiple SRS resources and reduces the overhead incurred to block out transmissions on certain OFDM symbols.

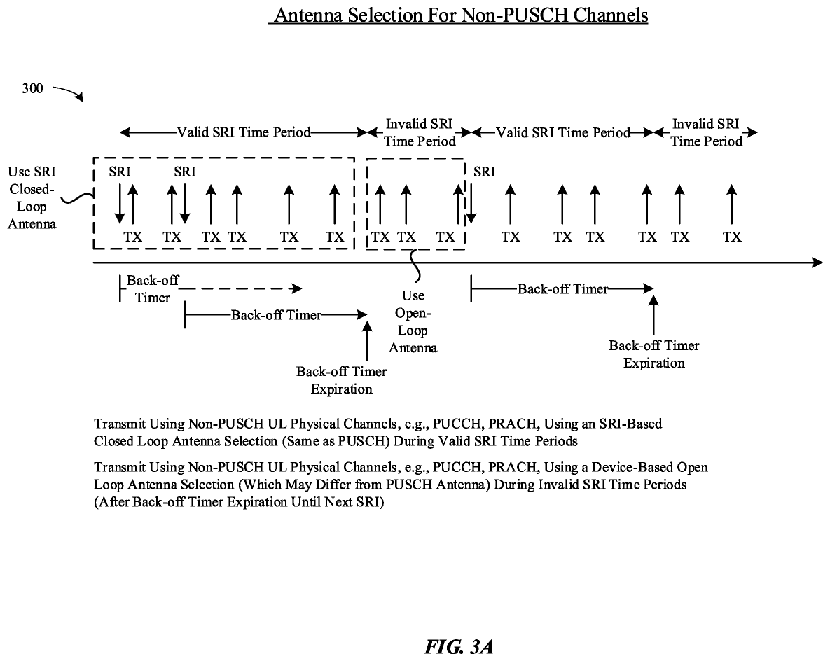

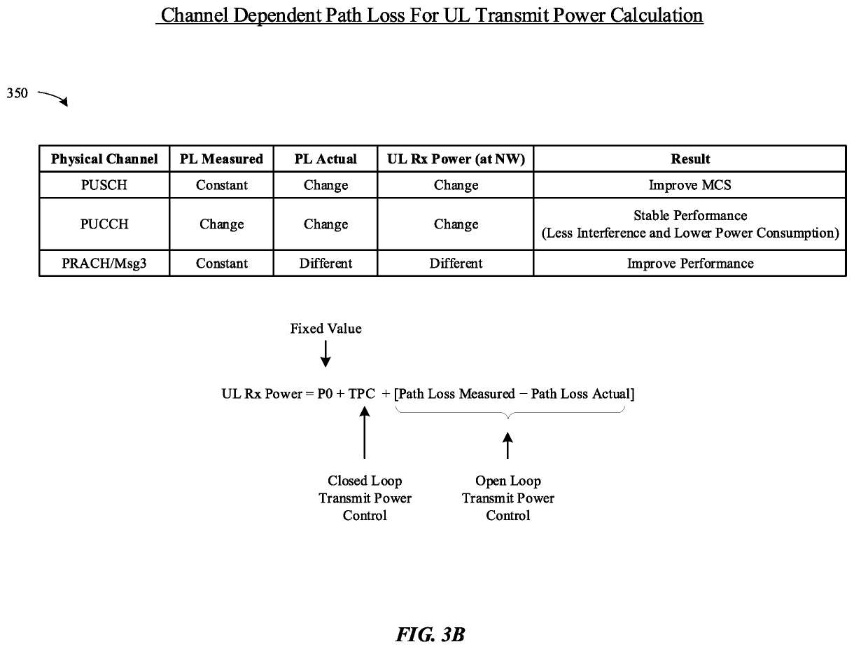

FIG. 3A illustrates a diagram 300 of an example of antenna selection for physical layer channels other than the PUSCH, i.e., for non-PUSCH channels. The wireless device 102 extends the use of SRI-based feedback provided for closed-loop antenna selection for the PUSCH to additional UL physical layer channels, such as the physical uplink control channel (PUCCH) and the physical random access channel (PRACH). The wireless device 102 starts (or resets) a back-off timer after receiving an SRI value from the cellular wireless network, the SRI value indicating an antenna (or antenna port) to use for the PUSCH based on measurements of SRS resources previously transmitted by the wireless device 102 to the cellular wireless network. The back-off timer can delineate a back-off time period during which the most recently receive SRI value can be considered valid by the wireless device 102 for UL transmissions on one or more non-PUSCH UL physical channels. The wireless device 102 can transmit the PUSCH based on the closed-loop antenna selection indicated by the most recently received SRI value independent of the state of the back-off timer. The wireless device 102 can transmit one or more non-PUSCH UL physical layer channels using the same closed-loop antenna selection indicated by the most recently received SRI value for the PUSCH when the back-off timer has not expired, i.e., during a back-off time period for which the most recently SRI value can be considered valid for non-PUSCH UL physical channel transmissions. For non-PUSCH transmissions that occur after the back-off timer has expired (and before reception of a new SRI value that resets the back-off timer), i.e., during a time period when the SRI value can be considered invalid for non-PUSCH transmissions, the wireless device 102 selects an antenna port for transmission of the PUCCH or the PRACH using an open-loop antenna selection procedure, e.g., based on measurements of downlink (DL) signals received by the wireless device 102 from the cellular wireless network. In some cases, the open-loop selected antenna used for the PUCCH and the PRACH can be the same as the closed-loop selected antenna used for the PUSCH. In some cases, the open-loop selected antenna used for the PUCCH and the PRACH can differ from the closed-loop selected antenna used for the PUSCH.

FIG. 3B illustrates a table 350 of an example of UL transmit power calculation using channel dependent path loss by a wireless device 102. The wireless device 102 can determine UL transmit power levels for communication via an UL physical channel through an antenna (or antenna port) based on the specific UL physical channel being transmitted, e.g., different UL physical channels transmitted via the same physical antenna (or antenna port) can be transmitted at different UL transmit power levels. The PUSCH UL physical layer channel is transmitted using resources allocated by the cellular wireless network to the wireless device 102 for the PUSCH and is not shared with other wireless devices 102 connected to the same cell of the cellular wireless network. A power level for an UL physical layer channel received at the cellular wireless network can be calculated based on a fixed value PO, a closed-loop transmit power control (TPC) value set by the cellular wireless network, and an open-loop transmit power control determined by the wireless device 102 using a measured downlink path loss, where the wireless device 102 determines the UL transmit power level, at least in part, to compensate for the expected uplink path loss (assuming reciprocity in the uplink and downlink directions, the measured downlink path loss provides an indication of the expected uplink path loss). The actual amount of path loss incurred will depend on the antenna (or antenna port) selected for the UL transmission. The wireless device 102 can calculate UL transmission power differently for each UL physical channel using either i) DL path loss measurements obtained via the closed-loop SRI selected antenna or ii) DL path loss measurements obtained via the open-loop antenna selection. The PUSCH is transmitted via the closed-loop selected antenna; however, the wireless device 102 can use a DL path loss measurement obtained via the open-loop antenna for UL transmit power level calculations. The PUCCH and PRACH are transmitted using the closed-loop SRI selected antenna, when transmitted within a valid SRI time period or an open-loop selected antenna, which can be the same or different from the closed-loop SRI-selected antenna, when transmitted outside of valid SRI time periods. UL transmit power levels for the PUSCH can be calculated using the DL path loss measurements obtained via the open-loop antenna selection. This provides a constant (over a time-frame during which a most recent DL path loss measurement via the open-loop antenna selection procedure is valid) DL path loss value aligned between the wireless device and the cellular wireless network. UL performance for the PUSCH can accommodate higher modulation and coding selection (MCS) values in some situations, such as when the actual UL path loss is less than the measured DL path loss used for the UL transmit power level calculation, as the resulting UL received power level at the cellular wireless network for the PUSCH can be higher. UL transmit power levels for the PRACH can also be calculated using the DL path loss measurements obtained via the open-loop antenna selection and can thereby achieve higher performance for the PRACH based on higher UL transmit power levels. UL transmit power levels for the PUCCH can be calculated using the corresponding antenna used for the PUCCH transmission, i.e., the DL path loss measurement obtained via the closed-loop SRI-selected antenna, when using the SRI-selected antenna for the PUCCH, and the DL path loss measurement obtained via the open-loop antenna, when using the open-loop antenna for the PUCCH. The DL path loss measurements are selected according to the corresponding antenna used for the PUCCH to achieve stable performance with lower UL transmit power levels resulting in less interference when received at the cellular wireless network, as the PUCCH is a shared channel used by other wireless devices as well as the wireless device 102.

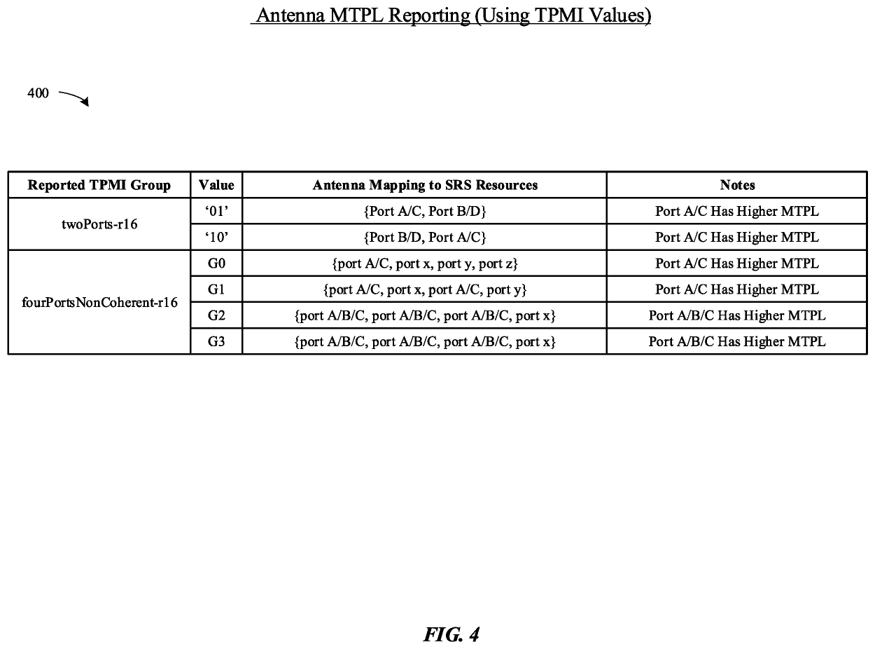

FIG. 4 illustrates a table 400 of an example of reporting antenna maximum transmit power level (MTPL) values by a wireless device 102 to a cellular wireless network using transmit precoding matrix indicator (TPMI) values. In some embodiments, the wireless device 102 reports a full power mode 2 configuration with only one transmit layer supported (UL MIMO with multiple transmit layers not supported). The full power mode 2 configuration was introduced in release 16 of the 5G NR wireless communication standard. While the use of the full power mode 2 configuration is intended for UL MIMO, in some circumstances a wireless device 102 can restrict transmissions to using a single layer only, even when using the full power mode 2 configuration. The full power mode 2 configuration advantageously allows for the cellular wireless network to configure the wireless device 102 with an SRS resource set 106 having four SRS resources, where each SRS resource can be used with a different antenna (or antenna port) of the wireless device 102. In some embodiments, the wireless device 102 transmits the four SRS resources via four different antennas (or antenna ports) and receives an antenna selection from the cellular wireless network via SRI information in a downlink control information (DCI) message, e.g., a first one-bit valued SRI and a second one-bit valued SRI to select one of the four different antennas (or antenna ports) to use for subsequent PUSCH transmission.

The wireless device 102 can also report to the cellular wireless network a full power mode 2 configuration with a TPMI group value to indicate a maximum transmit power level (MTPL) capability of antennas (or antenna ports) of the wireless device 102. The TPMI group value can indicate higher MTPL capability for certain antennas (or antenna ports). The wireless device 102 can send to the cellular wireless network in a capability report a two-port release 16(r16) TPMI group value, e.g., a two-bit designation of ‘01’ or ‘10’, or a four port non-coherent r16 TPMI Group value, e.g., a ‘g0’, ‘g1’, ‘g2’ or ‘g3’ value. The wireless device 102 uses the two port TPMI group designation when the wireless device 102 supports closed-loop antenna selection using two SRS resources. The wireless device 102 uses the four port TPMI group designation is used when the wireless device 102 supports closed-loop antenna selection using four SRS resources.

The wireless device 102 maps physical antennas (or antenna ports) of the wireless device 102 to codebook-usage SRS resources based on values reported for the TPMI group. Specific values for the TPMI group are provided to the cellular wireless network to indicate a relative MTPL capability of various antennas (or antenna ports) of the wireless device. When the two port r16 configuration is used, the wireless device maps antennas (or antenna ports) with higher MTPL values to the reported port index. When the four port non-coherent r16 configuration is used, the wireless device 102 maps antennas (or antenna ports) to G0, G1, G2 and G3 values to correspond to certain antennas (or antenna ports) that have higher MTPL values. The cellular wireless network can read the TPMI group value reported by the wireless device 102 and apply a transmit power adjustment (e.g., 3 dB) for antennas (or antenna ports) that have different MTPL values, e.g., some antennas (or antenna ports) may support higher maximum transmit power levels while other antennas may support lower maximum transmit power levels. In some cases, the wireless device 102 can transmit an SRS resource as a wideband signal at or near an MTPL level for a corresponding antenna (or antenna port) through which the SRS resource is transmitted. The wireless device 102 can transmit subsequent UL physical layer channel transmissions, e.g., PUSCH, PUCCH, or PRACH transmissions, as narrowband signals at a lower transmit power level. The cellular wireless network can account for the transmit power level differences when estimating signal metrics from received SRS resources and when selecting antennas (or antenna ports) for the wireless device 102 to subsequently use.

In some embodiments, the cellular wireless network uses a power headroom report (PHR) provided by the wireless device 102 to determine an MTPL value for an antenna (or antenna port). The cellular wireless network can transmit to the wireless device a DCI message that includes an SRI value, which designates an antenna (or antenna port) for the wireless device to use. The DCI message can be sent near the expiration of a periodic PHR timer. Upon expiration of the periodic PHR timer, the wireless device 102 determines and provides a PHR value to the cellular wireless network. The PHR received by the cellular wireless network can correspond to the antenna (or antenna port) selected by the most recently received SRI value. The cellular wireless network can accumulate PHR values for each of the antennas (or antenna ports) by cycling through different SRI values to designate different antennas (or antenna ports) and use the PHR values to determine MTPL values for the corresponding antennas (or antenna ports). With the MTPL values for the various antennas (or antenna ports), the cellular wireless network can apply MTPL differences to estimated SRS signal metrics when selecting an antenna (or antenna port) for the wireless device 102 to use (subsequently designated in an SRI sent to the wireless device 102).

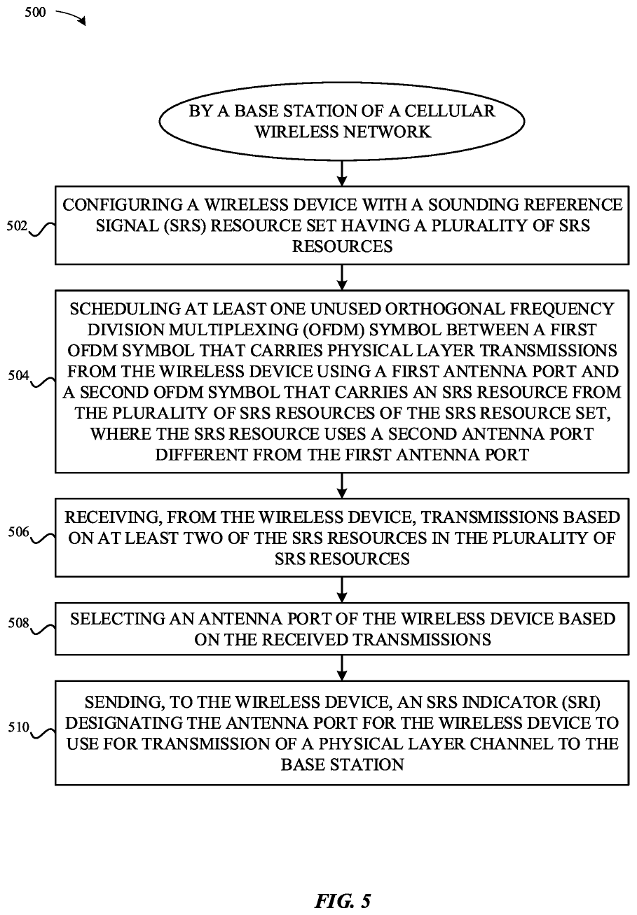

FIG. 5 illustrates a flowchart 500 of an exemplary method for closed-loop uplink (UL) transmit antenna selection for a wireless device 102 communicating with a base station (e.g., gNodeB 112) of a cellular wireless network. At 502, the base station configures the wireless device 102 with a sounding reference signal (SRS) resource set 106 having a plurality of SRS resources. At 504, the base station schedules at least one unused orthogonal frequency division multiplexing (OFDM) symbol between a first OFDM symbol that carries physical layer channel transmissions from the wireless device 102 using a first antenna port and a second OFDM symbol that carries an SRS resource from the plurality of SRS resources of the SRS resource set 106, where the SRS resource 106 uses a second antenna port different from the first antenna port. At 506, the base station receives, from the wireless device 102, transmissions based on at least two of the SRS resources in the plurality of SRS resources. At 508, the base station selects an antenna port of the wireless device 102 based on the received transmissions. At 510, the base station sends to the wireless device 102, an SRS indicator (SRI) designating the antenna port for the wireless device 102 to use for transmission of a physical layer channel to the base station. For the method of FIG. 5, The wireless device 102 is configured to use a frequency domain duplexing (FDD) configuration to communicate with the base station of the cellular wireless network.

In some embodiments, the first OFDM symbol and the second OFDM symbol occur in an identical slot of an UL frame. In some embodiments, the first OFDM symbol and the second OFDM symbol occur in distinct sequential slots of an UL frame. In some embodiments, the base station configures the wireless device 102 to transmit the plurality of SRS resources in the second OFDM symbol. In some embodiments, the wireless device 102 is configured to not send UL transmissions to the base station of the cellular wireless network during the at least one unused OFDM symbol. In some embodiments, the SRS resource set 106 includes two or four SRS resources, each SRS resource associated with a distinct antenna port of the wireless device 102. In some embodiments, the wireless device 102 is configured for codebook based physical layer uplink shared channel (PUSCH) transmissions. In some embodiments, the physical layer channel transmissions include physical layer uplink shared channel (PUSCH) transmissions.

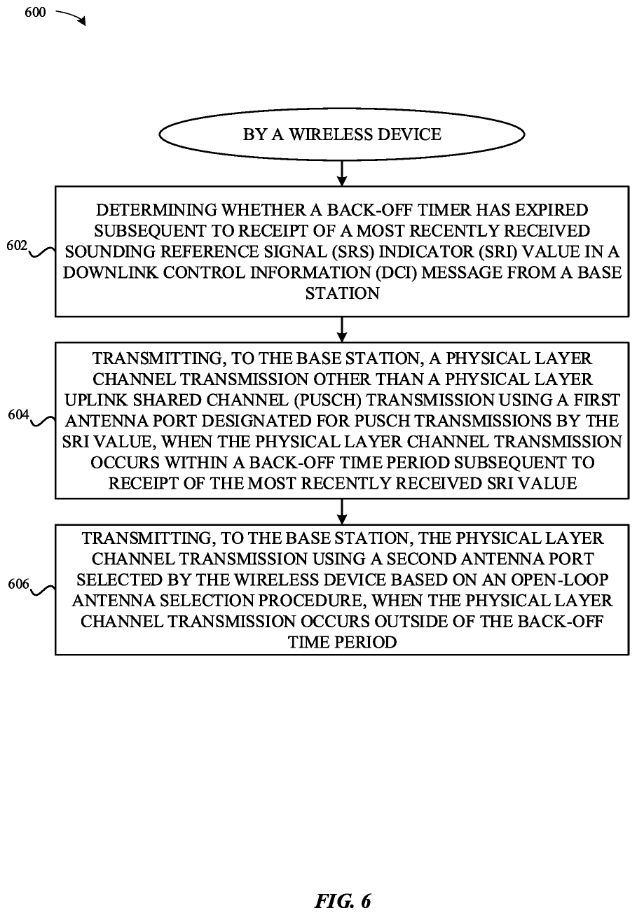

FIG. 6 illustrates a flowchart 600 of an exemplary method for uplink (UL) transmit antenna selection for a wireless device 102 communicating with a base station (e.g., gNodeB 112) of a cellular wireless network. At 602, the wireless device 102 determines whether a back-off timer has expired subsequent to receipt of a most recently received sounding reference signal (SRS) indicator (SRI) value in a downlink control information (DCI) message from a base station of a cellular wireless network. At 604, the wireless device 102 transmits, to the base station, a physical layer channel transmission other than a physical layer uplink shared channel (PUSCH) transmission using a first antenna port designated for PUSCH transmissions by the SRI value, when the physical layer channel transmission occurs within a back-off time period subsequent to receipt of the most recently received SRI value. At 606, the wireless device 102 transmits, to the base station, the physical layer channel transmission using a second antenna port selected by the wireless device 102 based an open-loop antenna selection procedure, when the physical layer channel transmission occurs outside of the back-off time period. For the method of FIG. 6, the back-off timer of the wireless device 102 expires at the end of the back-off time period subsequent to receipt of the most recently received SRI value.

In some embodiments, the wireless device 102 initiates or resets the back-off timer in response to receipt of an SRI value from the base station. In some embodiments, the physical layer channel transmission includes a physical uplink control channel (PUCCH) transmission, and the wireless device 102 calculates an UL transmit power for the PUCCH transmission based on a path loss estimate determined by wireless device 102 for the corresponding antenna port used for the PUCCH transmission. In some embodiments, the physical layer channel transmission includes a physical random access channel (PRACH) transmission, and the wireless device 102 calculates an UL transmit power for the PRACH transmission based on a path loss estimate determined by wireless device 102 for the second antenna port, independent of whether the first antenna port or the second antenna port is used for the PRACH transmission. In some embodiments, the wireless device 102 transmits, to the base station, a PUSCH transmission, via a first antenna port designated for PUSCH transmissions by the SRI value, using an UL transmit power calculated based on a path loss estimate determined by the wireless device 102 for the second antenna port based on the open-loop antenna selection procedure. In some embodiments, the wireless device 102 selects the second antenna port based on signal strength measurements of downlink (DL) signals received from the base station.

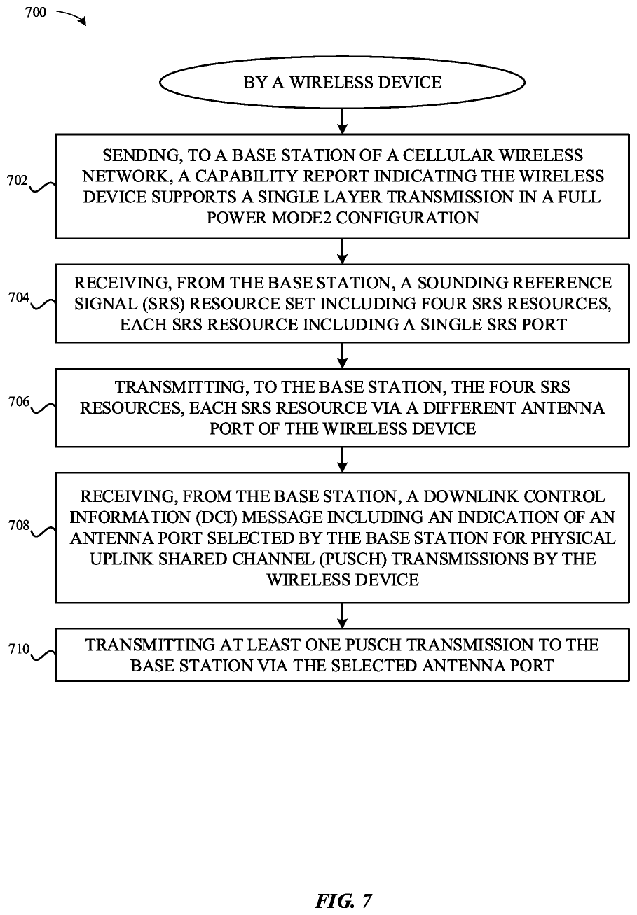

FIG. 7 illustrates a flowchart 700 of another exemplary method for uplink (UL) transmit antenna selection for a wireless device 102 communicating with a base station (e.g., gNodeB 112) of a cellular wireless network. At 702, the wireless device 102 sends, to the base station, a capability report indicating the wireless device 102 supports single layer transmission in a full power mode2 configuration. At 704, the wireless device 102 receives, from the base station, a sounding reference signal (SRS) resource set including four SRS resources, each SRS resource including a single SRS port. At 706, the wireless device 102 transmits to the base station, the four SRS resources, each SRS resource via a different antenna port of the wireless device 102. At 708, the wireless device 102 receives, from the base station, a downlink control information (DCI) message including an indication of an antenna port selected by the base station for physical uplink shared channel (PUSCH) transmissions by the wireless device 102. At 710, the wireless device 102 transmits at least one PUSCH transmission to the base station via the selected antenna port. For the method of FIG. 7, the wireless device 102 is configured for codebook based PUSCH transmissions. In some embodiments, the DCI message includes two SRS indicator (SRI) bits to designate the selected antenna port.

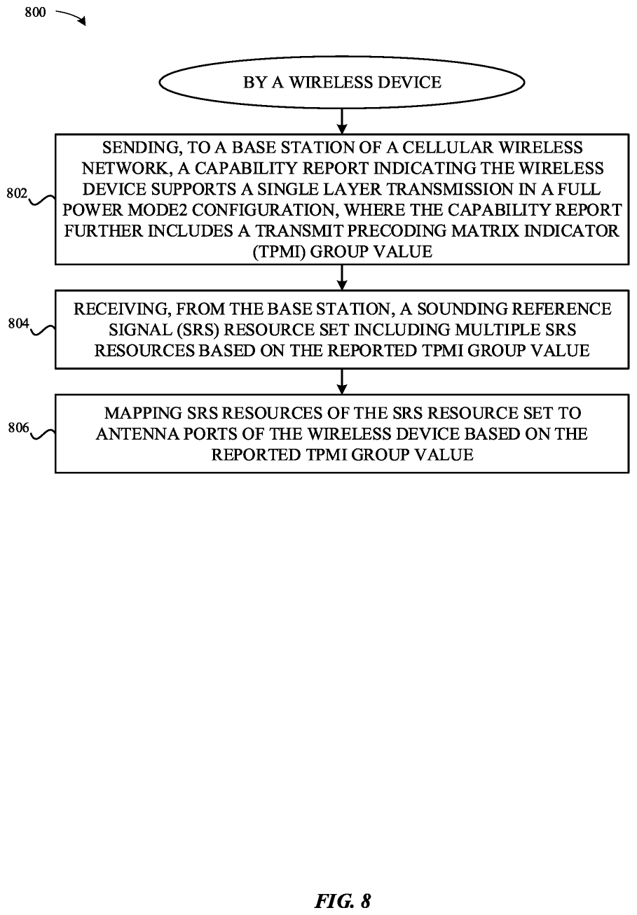

FIG. 8 illustrates a flowchart 800 of an exemplary method for communicating maximum transmit power level (MTPL) information for multiple antenna ports of a wireless device 102 to a base station (e.g., gNodeB 112) of a cellular wireless network. At 802, the wireless device 102 sends, to the base station, a capability report indicating the wireless device 102 supports single layer transmission in a full power mode2 configuration, where the capability report further includes a transmit precoding matrix indicator (TPMI) group value. At 804, the wireless device 102 receives, from the base station, a sounding reference signal (SRS) resource set including multiple SRS resources based on the reported TPMI group value. At 806, the wireless device 102 maps SRS resources of the SRS resource set to antenna ports of the wireless device 102 based on the reported TPMI group value.

In some embodiments: i) the reported TPMI group value indicates the wireless device 102 supports closed-loop antenna selection using two SRS resources, ii) the SRS resource set includes the two SRS resources, and iii) the wireless device 102 maps at least one antennas port of the wireless device 102 having a higher MTPL value to the reported TPMI group value. In some embodiments: i) the reported TPMI group value indicates the wireless device 102 supports closed-loop antenna selection using four SRS resources with non-coherent transmission, ii) the SRS resource set includes the four SRS resources, and iii) the wireless device 102 maps at least one antennas port of the wireless device 102 having a higher MTPL value to the reported TPMI group value.

### Representative Exemplary Apparatus

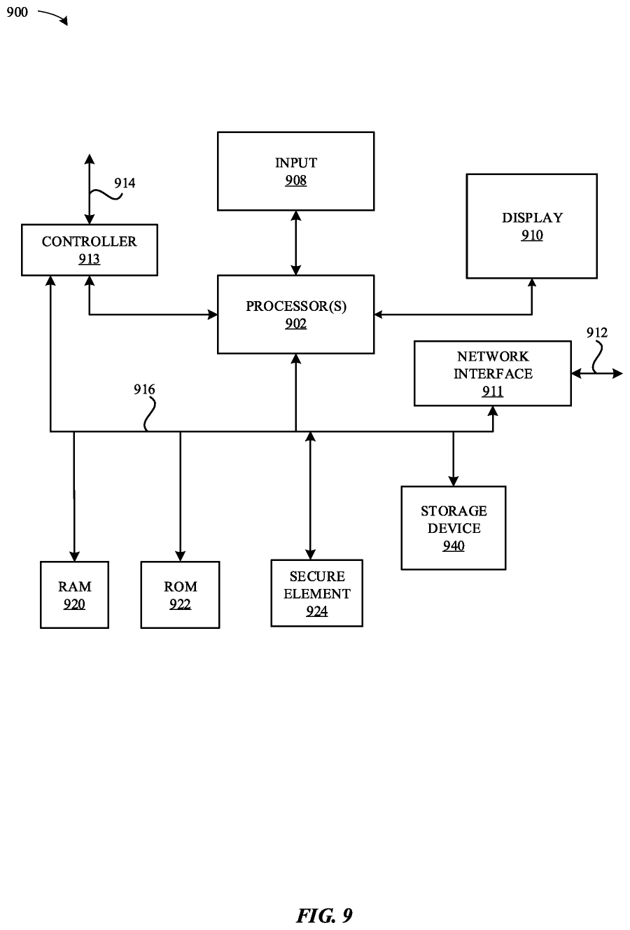

FIG. 9 illustrates in block diagram format an exemplary computing device 900 that can be used to implement the various components and techniques described herein, according to some embodiments. In particular, the detailed view of the exemplary computing device 900 illustrates various components that can be included in a wireless device, e.g., wireless device 102. As shown in FIG. 9, the computing device 900 can include one or more processors 902 that represent microprocessors or controllers for controlling the overall operation of computing device 900. In some embodiments, the computing device 900 can also include a user input device 908 that allows a user of the computing device 900 to interact with the computing device 900. For example, in some embodiments, the user input device 908 can take a variety of forms, such as a button, keypad, dial, touch screen, audio input interface, visual/image capture input interface, input in the form of sensor data, etc. In some embodiments, the computing device 900 can include a display 910 (screen display) that can be controlled by the processor(s) 902 to display information to the user (for example, information relating to incoming, outgoing, or active communication sessions). A data bus 916 can facilitate data transfer between at least a storage device 940, the processor(s) 902, and a controller 913. The controller 913 can be used to interface with and control different equipment through an equipment control bus 914. The computing device 900 can also include a network/bus interface 911 that couples to a data link 912. In the case of a wireless connection, the network/bus interface 911 can include wireless circuitry, such as a wireless transceiver and/or baseband processor. The computing device 900 can also include a secure element 924. The secure element 924 can include an eUICC.

The computing device 900 also includes a storage device 940, which can include a single storage or a plurality of storages (e.g., hard drives), and includes a storage management module that manages one or more partitions within the storage device 940. In some embodiments, storage device 940 can include flash memory, semiconductor (solid state) memory or the like. The computing device 900 can also include a Random-Access Memory (RAM) 920 and a Read-Only Memory (ROM) 922. The ROM 922 can store programs, utilities or processes to be executed in a non-volatile manner. The RAM 920 can provide volatile data storage, and stores instructions related to the operation of the computing device 900.

### Wireless Terminology

In accordance with various embodiments described herein, the terms “wireless communication device,” “wireless device,” “mobile device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) LTE, LTE Advanced (LTE-A), 5G, and/or 5G-Advanced or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode user equipment (UE) can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High Speed Packet Access (HSPA+) network or a Code Division Multiple Access (CDMA) 2000 Evolution-Data Only (EV-DO) network, when 5G, LTE and LTE-A networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

1. A method for closed-loop uplink (UL) transmit antenna selection for a wireless device communicating with a base station of a cellular wireless network, the method comprising:
by the base station:
configuring the wireless device with a sounding reference signal (SRS) resource set having a plurality of SRS resources;
scheduling at least one unused orthogonal frequency division multiplexing (OFDM) symbol between a first OFDM symbol that carries physical layer channel transmissions from the wireless device using a first antenna port and a second OFDM symbol that carries an SRS resource from the plurality of SRS resources of the SRS resource set, where the SRS resource uses a second antenna port different from the first antenna port;
receiving, from the wireless device, transmissions based on at least two of the SRS resources in the plurality of SRS resources;
selecting an antenna port of the wireless device based on the received transmissions; and
sending, to the wireless device, an SRS indicator (SRI) designating the antenna port for the wireless device to use for transmission of a physical layer channel to the base station,
wherein the wireless device is configured to use a frequency domain duplexing (FDD) configuration to communicate with the base station of the cellular wireless network.

2. The method of claim 1, wherein the first OFDM symbol and the second OFDM symbol occur in an identical slot of an UL frame.

3. The method of claim 1, wherein:
the first OFDM symbol and the second OFDM symbol occur in distinct sequential slots of an UL frame.

4. The method of claim 1, further comprising:
by the base station:
configuring the wireless device to transmit the plurality of SRS resources in the second OFDM symbol.

5. The method of claim 1, wherein the wireless device is configured to not send UL transmissions to the base station of the cellular wireless network during the at least one unused OFDM symbol.

6. The method of claim 1, wherein the SRS resource set includes two or four SRS resources, each SRS resource associated with a distinct antenna port of the wireless device.

7. The method of claim 1, wherein the wireless device is configured for codebook based physical layer uplink shared channel (PUSCH) transmissions.

8. The method of claim 1, wherein the physical layer channel transmissions comprise physical layer uplink shared channel (PUSCH) transmissions.

9. A method for uplink (UL) transmit antenna selection for a wireless device communicating with a base station of a cellular wireless network, the method comprising:
by the wireless device:
determining whether a back-off timer has expired subsequent to receipt of a most recently received sounding reference signal (SRS) indicator (SRI) value in a downlink control information (DCI) message from the base station;
transmitting, to the base station, a physical layer channel transmission other than a physical layer uplink shared channel (PUSCH) transmission using a first antenna port designated for PUSCH transmissions by the SRI value, when the physical layer channel transmission occurs within a back-off time period subsequent to receipt of the most recently received SRI value; and
transmitting, to the base station, the physical layer channel transmission using a second antenna port selected by the wireless device based an open-loop antenna selection procedure, when the physical layer channel transmission occurs outside of the back-off time period,
wherein the back-off timer expires at the end of the back-off time period subsequent to receipt of the most recently received SRI value.

10. The method of claim 9, further comprising:
by the wireless device:
initiating or resetting the back-off timer in response to receipt of an SRI value from the base station.

11. The method of claim 9, wherein:
the physical layer channel transmission comprises a physical uplink control channel (PUCCH) transmission; and
the wireless device calculates an UL transmit power for the PUCCH transmission based on a path loss estimate determined by wireless device for a corresponding antenna port used for the PUCCH transmission.

12. The method of claim 9, wherein:
the physical layer channel transmission comprises a physical random access channel (PRACH) transmission; and
the wireless device calculates an UL transmit power for the PRACH transmission based on a path loss estimate determined by wireless device for the second antenna port, independent of whether the first antenna port or the second antenna port is used for the PRACH transmission.

13. The method of claim 9, further comprising:
by the wireless device:
transmitting, to the base station, a PUSCH transmission, via a first antenna port designated for PUSCH transmissions by the SRI value, using an UL transmit power calculated based on a path loss estimate determined by the wireless device for the second antenna port based on the open-loop antenna selection procedure.

14. The method of claim 9, wherein the wireless device selects the second antenna port based on signal strength measurements of downlink (DL) signals received from the base station.

15.-20. (canceled)

21. An apparatus for operation in a wireless device, the apparatus comprising at least one processor communicatively coupled to a memory storing instructions that, when executed by the at least one processor, configure the wireless device to perform actions including:
determining whether a back-off timer has expired subsequent to receipt of a most recently received sounding reference signal (SRS) indicator (SRI) value in a downlink control information (DCI) message from a base station of a cellular wireless network;
transmitting, to the base station, a physical layer channel transmission other than a physical layer uplink shared channel (PUSCH) transmission using a first antenna port designated for PUSCH transmissions by the SRI value, when the physical layer channel transmission occurs within a back-off time period subsequent to receipt of the most recently received SRI value; and
transmitting, to the base station, the physical layer channel transmission using a second antenna port selected by the wireless device based an open-loop antenna selection procedure, when the physical layer channel transmission occurs outside of the back-off time period,
wherein the back-off timer expires at the end of the back-off time period subsequent to receipt of the most recently received SRI value

22.-23. (canceled)

24. The apparatus of claim 21, wherein the actions further include:
initiating or resetting the back-off timer in response to receipt of an SRI value from the base station.

25. The apparatus of claim 21, wherein:
the physical layer channel transmission comprises a physical uplink control channel (PUCCH) transmission; and
the wireless device calculates an UL transmit power for the PUCCH transmission based on a path loss estimate determined by wireless device for a corresponding antenna port used for the PUCCH transmission.

26. The apparatus of claim 21, wherein:
the physical layer channel transmission comprises a physical random access channel (PRACH) transmission; and
the wireless device calculates an UL transmit power for the PRACH transmission based on a path loss estimate determined by wireless device for the second antenna port, independent of whether the first antenna port or the second antenna port is used for the PRACH transmission.

27. The apparatus of claim 21, wherein the actions further include:
transmitting, to the base station, a PUSCH transmission, via a first antenna port designated for PUSCH transmissions by the SRI value, using an UL transmit power calculated based on a path loss estimate determined by the wireless device for the second antenna port based on the open-loop antenna selection procedure.

28. The apparatus of claim 21, wherein the wireless device selects the second antenna port based on signal strength measurements of downlink (DL) signals received from the base station.
